(19) United States
(12) Patent Application Publication
(10) Pub. No.: US 2006/0124237 A1
(43) Pub. Date: Jun. 15, 2006

(54) Device and method for performing a master processing operation

(75) Inventors: Brett W. Nordin, Chandler, AZ (US); Paul J. Lemens, Scottsdale, AZ (US)

Correspondence Address: PILLSBURY WINTHROP SHAW PITTMAN, LLP, P.O. BOX 10500, MCLEAN, VA, 22102, US

(73) Assignee: Xyron, Inc., Scottsdale, AZ (US)

(21) Appl. No.: 11/346,441

(22) Filed: Feb. 3, 2006

Related U.S. Application Data
(63) Continuation of application No. 10/727,561, filed on Dec. 5, 2003.
(60) Provisional application No. 60/433,606, filed on Dec. 16, 2002.

(51) Int. Cl. B32B 33/00

(52) U.S. Cl. 156/289; 428/40.1

(57) ABSTRACT

The present invention relates to a device and method for performing a master processing operation on a selected substrate.

### CROSS-REFERENCE TO RELATED APPLICATIONS

The present application is a continuation of U.S. patent application Ser. No. 10/727,561, filed Dec. 5, 2003 and currently pending, which claims priority from U.S. Provisional Patent Application No. 60/433,606 filed Dec. 16, 2002 and now abandoned, the entire contents of which are both incorporated herein by reference.

### FIELD OF THE INVENTION

The present invention relates to a device and method for performing a master processing operation on a selected substrate.

### BACKGROUND OF THE INVENTION

Typically, to laminate a document, a user must use a laminator, such as is shown in U.S. Pat. No. 5,580,417. However, the cost of a laminator may not make economic sense for the infrequent or one-time user. To this end, the art has provided laminating sheets. These laminating sheets typically comprise two laminating films, at least one of which has a pressure-sensitive adhesive on the inner surface thereof, and a release liner positioned between the films. To use a laminating sheet, the user separates the sheets and removes the release liner; places the item to be laminated in position on one of the sheets; brings the sheets back together; and then applies pressure to the films to ensure the pressure-sensitive adhesive bonds the films securely together. Typically, the user will have to spend a fair deal of effort in applying pressure to ensure any entrapped “air bubbles” are freed from between the films. These air bubbles are created because the two laminating films are brought together manually, and the typical user tends to attend to aligning and securing the edges of the films together before smoothing out the center.

### SUMMARY OF THE INVENTION

One aspect of the invention provides a device for performing a master processing operation on a selected substrate. The device comprises a base substrate; an adhesive carrier substrate having an inner surface facing the base substrate; a layer of pressure-sensitive adhesive provided on the inner surface of the adhesive carrier substrate; and a release liner separating the base substrate from the adhesive carrier substrate. The release liner is folded along a fold line extending in a transversely extending direction to define two portions, one of which is an activating portion. The release liner has an outer surface facing the inner surface of the adhesive carrier substrate and also an inner surface of the base substrate. The outer surface is a release surface. The base substrate is separable from the release liner and the adhesive carrier substrate to enable the selected substrate to be positioned in a master processing position. The activating portion enables the master processing operation to be performed with the selected substrate in the master processing position by pulling the activating portion of the release liner in an activating direction generally perpendicular to the transverse direction and generally parallel to the base substrate and the selected substrate so as to progressively remove the release liner from the adhesive carrier substrate and cause the pressure-sensitive adhesive to adhere to the selected substrate and any peripheral portions of the base substrate extending adjacent the periphery of the selected substrate.

Another aspect of the invention provides a method for performing a master processing operation on a selected substrate. The method comprises:
providing a device comprising:
   (i) a base substrate,
   (ii) an adhesive carrier substrate having an inner surface facing the base substrate,
   (iii) a layer of pressure-sensitive adhesive provided on the inner surface of the adhesive carrier substrate, and
   (iv) a release liner separating the base substrate from the adhesive carrier substrate, and
separating the base substrate from the release liner and the adhesive carrier substrate to enable the selected substrate to be positioned in a master processing position;
positioning the selected substrate in the master processing position; and
with the selected substrate in the master processing position, pulling the release liner in an activating direction generally parallel to the base substrate and the selected substrate so as to progressively remove the release liner from the adhesive carrier substrate and cause the pressure-sensitive adhesive to adhere to the selected substrate and any peripheral portions of the base substrate extending adjacent the periphery of the selected substrate.

This methodology may be performed in a device with or without a folded activating portion on the release liner.

Other objects, advantages, and aspects of the invention will become apparent from the following detailed description, the accompanying drawings, and the appended claims.

### BRIEF DESCRIPTION OF THE DRAWINGS

FIG. 1 is a perspective view of a device constructed in accordance with the principles of the present invention;

FIG. 2 is a broken-away cross-sectional view taken in the activating direction showing the stack-up of substrates in the device of FIG. 1, with the selected substrate in the master processing position thereof;

FIG. 3 is a top plan view of an alternative device constructed in accordance with the present invention;

FIG. 4 is a cross-sectional side view showing the base substrate folded back from the release liner and the adhesive carrier substrate, with the selected substrate in a master processing position;

FIG. 5 is a view similar to FIG. 4, with the release liner being pulled half-way in the activating direction; and

FIG. 6 is a view similar to FIG. 4, with the operation completed.

### DETAILED DESCRIPTION OF AN EXEMPLARY EMBODIMENT OF THE INVENTION

The Figures show a device, generally indicated at 10, for performing a laminating operation on a selected substrate 12. As will be discussed in further detail below, the invention may be used to perform any kind of master processing operation, including, for example, laminating, adhesive transfer, and/or magnet making. However, the invention will first be discussed in the context of a laminating operation for purposes of conveying a basic understanding of the invention.

The device 10 shown in the Figures is an exemplary embodiment of the present invention and is not intended to be limiting. The device 10 comprises a base substrate 14 and an adhesive carrier substrate 16. The adhesive carrier substrate 16 has an inner surface 18 facing the base substrate 14. A layer of pressure-sensitive adhesive (not shown) is provided on the inner surface 18 of the adhesive carrier substrate 16.

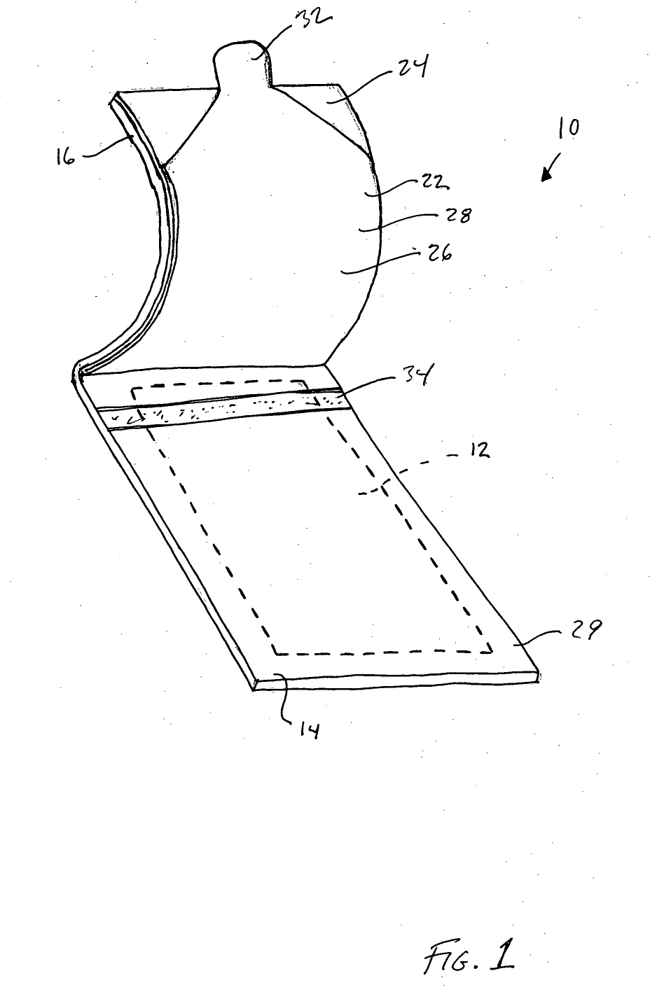

The base substrate 14 and the adhesive carrier substrate 16 may be made of any material, and may be transparent or translucent laminating films. For example, each of these substrates 14, 16 may be a transparent bi-axially oriented polypropylene laminating film. Also, the base substrate 14 could be a polypropylene while the base substrate 14 could be a polyester. These examples are in no way intended to be limiting. Further, the base substrate 14 and the adhesive carrier substrate 16 may have any shape or configuration. In the illustrated embodiment, that shape is rectangular. Alternatively, the shape of these substrates 14, 16 could be circular, ovular, triangular, or any other conceivable shape. Further, the substrates 14, 16 need not be identical, although that is preferable. As shown in FIG. 1, the base and adhesive carrier substrates 14, 16 are part of a single sheet folded along a transversely extending fold line. However, this is not intended to be limiting and the base and adhesive carrier substrates 14, 16 may be made from two separate sheets, and/or may be made of different materials. If separate sheets are used, it is preferable to bond them together in the region where the fold is located for substrates 14 and 16.

The pressure-sensitive adhesive used may be of any type, including, but not limited to, a UV cured adhesive, an acrylic based emulsion, holt melt applied or any other type of adhesive. The adhesive may be provided on the inner surface 18 in any manner, including by pattern coating or coating the entirety of the inner surface 18. Preferably, but not necessarily, when the adhesive carrier substrate 16 is a transparent or translucent laminating film, the adhesive will likewise be essentially transparent so as to minimize obscuring of the selected substrate 12.

A release liner 22 separates the base substrate 14 from the adhesive carrier substrate 16. The release liner 22 is folded along a fold line 23 extending in a transversely extending direction to define two portions. In the illustrated embodiment, these two portions are a following portion 24 facing the inner surface 18 of the adhesive carrier substrate 16 and an activating portion 26 facing the inner surface 29 of the base substrate 14. The release liner 22 has an outer surface 28 facing the inner surface 18 of the adhesive carrier substrate 16 on the following portion 24 thereof and also facing the inner surface 29 of the base substrate 14 on the activating portion 26 thereof. The outer surface 28 is a release surface. At the least, the part of the outer surface 28 on the following portion 24 should be a release surface, but the outer surface 28 on the activating portion 26 may also be a release surface. The release liner 22 may be made of any suitable material and the release characteristics of the outer surface 28 may be provided in any way. For example, the release liner 22 may be a paper web with at least the outer surface 28 thereof coated with any suitable release material, such as, for example, a silicone. Likewise, the release liner 22 may be made of bi-axially oriented polypropylene and coated with any suitable release material, such as, for example, a silicone.

In the illustrated embodiment, the activating portion 26 includes a tab 32 extending out from between the base substrate 14 and the adhesive carrier substrate 16 for facilitating manual grasping and pulling thereof. The presence of this tab 32 is not necessary and should not be considered limiting. The activating portion 26 may be tapered toward the tab 32 as shown in FIG. 1, but that also is not necessary and should not be considered limiting. For example, the activating portion 26 may include a string (not shown) for facilitating manual grasping and pulling thereof.

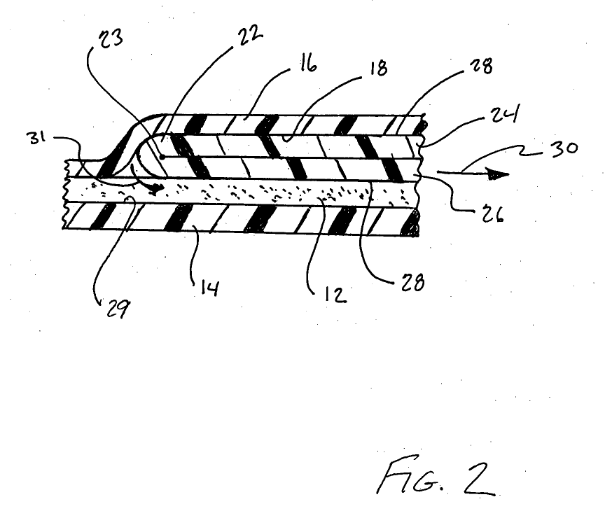

The base substrate 14 is separable from the release liner 22 and the adhesive carrier substrate 16 to enable the selected substrate 12 to be positioned in a master processing position between the release liner 22 and the base substrate 14 when the base substrate 14, release liner 22 and adhesive carrier substrate 16 are folded back into parallel relation, which position can be appreciated from the positioning of the selected substrate 12 in FIGS. 1 and 2. As an optional feature, the base substrate 12 includes a pressure-sensitive adhesive 34 on the inner surface 29 thereof. This adhesive 34 is used as an optional feature to help keep the selected substrate 12 in place during the master processing operation. Preferably, the pressure-sensitive adhesive 34 on the inner surface of the base substrate is a repositionable pressure-sensitive adhesive adapted for repositionably adhering the selected substrate in position during the operation. This enables the positioning of the selected substrate 12 to be corrected prior to performing the master processing operation. In the illustrated embodiment, this repositionable adhesive is provided as a strip extending transversely across the base substrate 14. If the base substrate is a transparent or translucent laminating film, it is preferred, but not necessary, that the adhesive 34 be essentially transparent so as to minimize obscuring of the selected substrate 12. Alternatively, the liner 22 could be pulled out slightly to expose the end of the adhesive on substrate 16, which would allow the user to keep the selected substrate 12 in place when bringing substrates 14 and 16 back together, thus engaging the exposed portion of adhesive with the selected substrate 12.

The activating portion 26 enables the laminating operation to be performed with the selected substrate 12 in the master processing position by pulling the activating portion 26 of the release liner 22 by the tab 32 in an activating direction 30 generally perpendicular to the transverse direction and generally parallel to the selected substrate 12 and the base substrate 14. This action progressively removes the following portion 24 from the adhesive carrier substrate 16 and withdraws the release liner 22 from between the adhesive carrier substrate 16 and the base 14 and selected substrates 12. The movement of the release liner 24 may be described as a progressive rolling or peeling motion. This enables the pressure-sensitive adhesive to adhere to the selected substrate 12 and any peripheral portions of the base substrate 12 extending adjacent the periphery of the selected substrate 12 and affecting adhesive bonding between the base substrate 14, the selected substrate 12, and the adhesive carrier substrate 16. Once the release liner 22 is fully withdrawn from between the substrates, the operation is completed and the liner 22 may be discarded.

In the illustrated embodiment, the activating portion 26 of the release liner 22 faces the base substrate 14 and the selected substrate 12, and the following portion 24 faces the adhesive carrier substrate 16. However, the invention may be practiced with these portions reversed, i.e., with the activating portion 26 facing the adhesive carrier substrate 16 and the following portion 24 facing the selected substrate 12.

The inventors believe that the embodiment of FIGS. 1 and 2 functions effectively because the progressive rolling movement of the release liner 22 tends to pull the adhesive carrier substrate 16 towards and into contact with the base substrate 14 and the selected substrate 12. Specifically, as a portion of the following portion 24 is removed off the adhesive carrier substrate 16, it folds underneath the remainder of the following portion 24 that is still engaged with the adhesive carrier substrate. 16 (see arrow 31 in FIG. 2). The light bond between the outer surface 28 will pull the portion of the adhesive carrier portion 16 from which it has just been removed toward and into contact with the selected substrate 12 and the base substrate 14. Additionally, the inventors believe that the pulling force on the activating portion 26 may result in slight tension being applied to the adhesive carrier substrate 16, which may help pull the adhesive carrier substrate 16 into engagement with the selected substrate 12 and the base substrate 14.

In the situation where the activating portion 26 is adjacent the adhesive carrier substrate 16 and the following portion 24 faces the base substrate 14, the invention still functions effectively. The inventors believe that in this embodiment, the tension applied to the adhesive carrier substrate 16 by pulling the activating portion 26 plays a more significant role in bringing the adhesive carrier substrate into contact with the base substrate 14 and the selected substrate 12. This is because the activating portion 26 is engaged directly with the pressure-sensitive adhesive, and more tension is likely to be created as a result of the release surface 28 sliding over the adhesive in the activating direction.

In either embodiment, the inventors believe static cling may also play a role in assisting the base substrate 14 and adhesive carrier substrate in coming together, particularly where very thin films are used.

The explanation provided above is provided solely for purposes of explaining how the inventors believe the device operates, and is not intended to be binding or limiting.

The term “base substrate” should not be construed as denoting a bottom substrate, a substrate devoid of adhesive or a substrate on which the selected substrate 12 is necessarily placed during the processing operation. To the contrary, the base substrate 14 could be the top substrate and the user could place the adhesive on the release liner 22 during the processing operation. Also, the base substrate 14 could have a layer of adhesive thereon.

Alternative embodiments of the device 10 may be developed for other purposes. As described herein, the device 10 is used for laminating, but other uses for this technology are envisioned, and thus the device may be broadly referred to as a master processing device and the method performed therewith may be broadly referred to as a master processing operation. For example, the device 10 could be modified for use as a magnet making device. In a magnet making device, the adhesive carrier substrate 16 would be a magnetic substrate such as is disclosed in U.S. Patent Application No. 2001-0042590A1, incorporated herein by reference. Optionally, the base substrate 14 may be a transparent or translucent laminating film with the inner surface thereof having an affinity for bonding with the pressure-sensitive adhesive. This would enable the magnet substrate to be mounted to a backside of the selected substrate 12 and the laminating film to be mounted to the front side, thereby protecting the selected substrate 12 and creating a laminated magnet. Alternatively, the base substrate 14 could be a mask substrate that has an affinity for the adhesive and can be pulled away to strip off any excess adhesive on peripheral portions of the magnet substrate adjacent the selected substrate 12, thus creating an unlaminated magnet with no excess adhesive around the periphery of the selected substrate 12.

Likewise, the device 10 could be modified for use as an adhesive transfer device. In an adhesive transfer device, the adhesive carrier substrate 16 would be an adhesive transfer substrate and the inner surface thereof would be a release surface. As such, when the pressure-sensitive adhesive is bonded to the selected substrate 12, the selected substrate 12 and the adhesive transfer substrate can be separated with the adhesive remaining on the selected substrate 12. Optionally, the base substrate 14 may be a mask substrate and the inner surface thereof may have an affinity for bonding with the pressure-sensitive adhesive. The mask substrate can be pulled away from the selected substrate 12 and the adhesive transfer substrate to strip off any excess adhesive on peripheral portions of the transfer substrate adjacent the selected substrate 12.

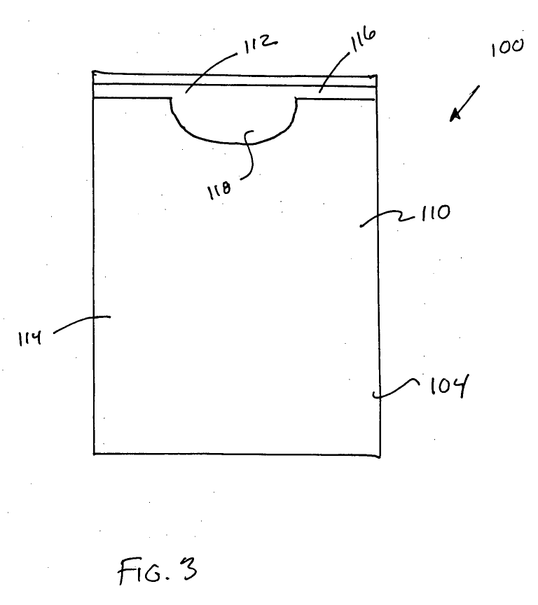

FIGS. 3-6 illustrate an alternative embodiment of the invention. The device 100 may be constructed for any of the uses discussed above, but for ease of explanation will be described in the context of being used for laminating. The device 100 is designed to laminate a selected substrate 102, and has a base substrate 104 and an adhesive carrier substrate 106. The adhesive carrier substrate 106 has an inner surface 108 facing the base substrate 104. A layer of pressure-sensitive adhesive (not shown) is provided on the inner surface 108 of the adhesive carrier substrate 106. For laminating, the base and adhesive carrier substrates 104 and 106 are preferably transparent films.

The base substrate 104 and adhesive carrier substrate 106 may be formed as a single piece and folded in half to define the two substrates. Preferably, however, they are formed as separate substrates and bonded together either by fusing or adhesive at the ends thereof as illustrated.

A release liner 110 separates the two substrates 104 and 106. The release liner 110 is folded at an end thereof to define an activating portion 112 and a following portion 114. The activating portion 112 is significantly shorter than the following portion 114 (e.g., less than 10% of its length). The release liner 110 has an outer surface 116 that is a release surface at least on the following portion 114 thereof. Optionally, the outer surface 116 may also be a release surface on the activating portion 112 simply for cost-effectiveness, as it is easier to simply coat the whole surface 116 prior to folding than controlling the application of release material to exclude the activating portion 112.

The activating portion 112 includes a tab 118. This tab is not essential, but is provided for ease of manual grasping by the user. The tab 118 may have use instructions printed thereon (e.g., “Pull” with an arrow pointing in the activating direction).

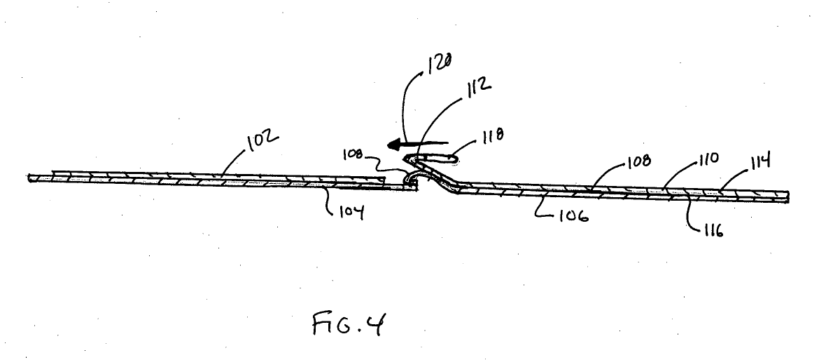

To use the device 100, the user places the adhesive carrier substrate 106 on a planar surface (such as a desktop) and folds the base substrate 114 back so it rests flat on the planar surface (see FIG. 4). Alternatively, the base substrate 104 could be laid down, and the release liner 110 and carrier substrate 106 could be folded back, or the device 100 could be opened and laid flat at once. The release liner 110 has a stiffness selected such that in this position the portion of the release liner 110 adjacent the fold line will delaminate and diverge from the adhesive carrier substrate 106 and stand out as illustrated. That is, the stiffness of the release liner 110 is selected such that when the device 100 is laid out as illustrated, the stiffness overcomes the light bond between the surface 116 and the adhesive, and the release liner 116 will delaminate from the region wherein the adhesive carrier substrate 106 is bent over and stand out as illustrated. The stiffness of the release liner 110 may be selected to achieve this effect based on the strength of the adhesive and its bond with the release surface (although this is a release surface, some light bonding still occurs).

The selected substrate 102 is positioned in its master processing position on the base substrate 104. To ensure the selected substrate is positioned perpendicular to the activating direction, its edge may be tucked into the nip defined where the base and adhesive carrier substrates 104 and 106 are joined. Advantageously, an edge of the selected substrate 102 may be contacted with the adhesive on the adhesive carrier substrate 116 exposed by the standout of the release liner 110 to help adhere it in place against movement during the operation. Such placement of the selected substrate 102, however, is not necessary.

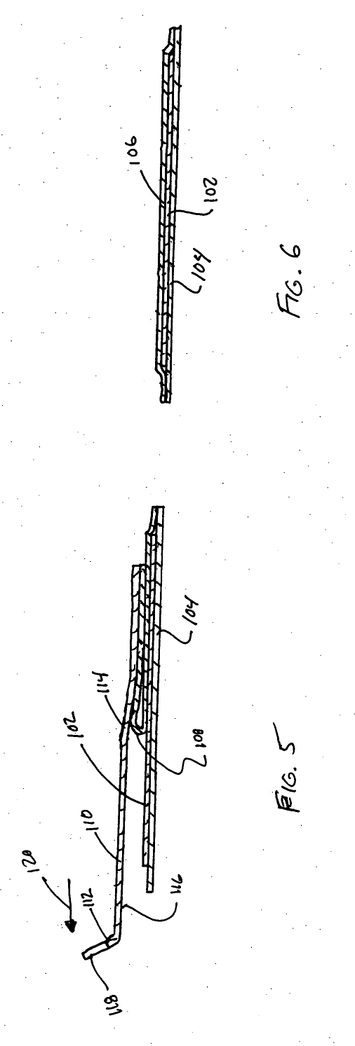

With the selected substrates in its master processing position, the user can then pull the activating portion 112 in the activating direction 120 so as to progressively remove the release liner 110 from the adhesive carrier substrates 106 and progressively pull the adhesive carrier substrate 106 over and into contact with the base substrate 104 and the selected substrate 104. This action can be appreciated from FIGS. 4 and 5. Once the release liner 110 is fully removed, the resulting product is as seen in FIG. 6.

The inventors believe the same principles of operation discussed above underlie the operation of this alternative embodiment. Any variations mentioned above for the earlier embodiments may be used for this alternative embodiment.

An advantage of both embodiments is that because the release liner is pulled so that the adhesive carrier substrate is engaged progressively with the selected substrate and the base substrate, there is less chance for air bubbles to form. While some air bubbles may occur, the progressive action of the device makes such occurrences less likely, or at least the bubbles will not be as large as with the prior art devices discussed above. Additionally, the pulling action on the release liner brings the substrates together in a smooth progressive manner that facilitates accurate alignment. These advantages are examples of advantages achieved by the illustrated embodiments and are not intended to be limiting or exclusive of other advantages that may be realized. Also, because the user only needs to pull the release liner to affect bonding, the user does not have to handle the adhesive carrier substrate with the adhesive exposed, thus reducing the chances of getting adhesive on his/her hands or mistakenly folding the carrier substrate so that it sticks to itself.

The device of the invention may be used for other applications and in other contexts, and the examples provided herein should not be considered limiting.

The foregoing embodiments have been provided to illustrate the structural and functional principles of the present invention and are not intended to be limiting. To the contrary, the present invention is intended to encompass all modifications, substitutions, and equivalents, within the spirit and scope of the following claims.

What is claimed:

1. A device for performing a master processing operation on a selected substrate, the device comprising:
a base substrate;
an adhesive carrier substrate having an inner surface facing the base substrate;
a layer of pressure-sensitive adhesive provided on the inner surface of the adhesive carrier substrate;
a release liner separating the base substrate from the adhesive carrier substrate, the release liner being folded along a fold line extending in a transversely extending direction to define two portions one of which is an activating portion;
the release liner having an outer surface facing the inner surface of the adhesive carrier substrate and an inner surface of the base substrate, the outer surface being a release surface;
the base substrate being separable from the release liner and the adhesive carrier substrate to enable the selected substrate to be positioned in a master processing position;
the activating portion enabling the master processing operation to be performed with the selected substrate in the master processing position by pulling the activating portion of the release liner in an activating direction generally perpendicular to the transverse direction and generally parallel to the base substrate and the selected substrate so as to progressively remove the release liner from the adhesive carrier substrate and cause the pressure-sensitive adhesive to adhere to the selected substrate and any peripheral portions of the base substrate extending adjacent the periphery of the selected substrate.

2. A device according to claim 1, wherein the base substrate includes a pressure-sensitive adhesive on the inner surface thereof.

3. A device according to claim 2, wherein the pressure-sensitive adhesive on the inner surface of the base substrate is a repositionable pressure-sensitive adhesive adapted for repositionably adhering the selected substrate in the master processing position during the master processing operation.

4. A device according to claim 3, wherein the repositionable adhesive is provided as a strip extending transversely across the base substrate.

5. A device according to claim 1, wherein the outer surface of the release liner is coated with a release material.

6. A device according to claim 1, wherein the activating portion includes a tab extending out from between the base substrate and the adhesive carrier substrate when the base substrate and the adhesive carrier substrate are together in parallel relation for facilitating manual grasping and pulling thereof.

7. A device according to claim 6, wherein the activating portion is tapered toward the tab.

8. A device according to claim 1, wherein the activating portion includes a string extending out from between the base substrate and the adhesive carrier substrate when the base substrate and the adhesive carrier substrate are together in parallel relation for facilitating manual grasping and pulling thereof.

9. A device according to claim 1, the base substrate and the adhesive carrier substrate are joined at edges thereof and wherein the release liner has a stiffness such that, when the adhesive carrier substrate and release liner are folded apart from the base substrate so that each of the adhesive carrier and base substrates are laid oh a planar surface, a portion of the release liner adjacent the fold line thereof will delaminate from the adhesive carrier substrate and stand out, thus enabling the master processing operation to be thereafter performed with the selected substrate in the master processing position on the base substrate by pulling the activating portion in the activating direction so as to progressively remove the release liner from the adhesive carrier substrate and progressively pull the adhesive carrier substrate over and into contact with the base substrate and the selected substrate.

10. A device according to claim 1, wherein the base substrate is a transparent or translucent laminating film.

11. A device according to claim 1, wherein the adhesive carrier substrate is a transparent or translucent laminating film.

12. A device according to claim 1, wherein both the base substrate and the adhesive carrier substrate are transparent or translucent laminating films.

13. A device according to claim 1, wherein the adhesive carrier substrate is a magnetic substrate.

14. A device according to claim 13, wherein the base substrate is a transparent or translucent laminating film and wherein the inner surface of the base substrate has an affinity for bonding with the pressure-sensitive adhesive.

15. A device according to claim 1, wherein the adhesive carrier substrate is an adhesive transfer substrate and the inner surface thereof is a release surface.

16. A device according to claim 15, wherein the base substrate is a mask substrate and the inner surface thereof has an affinity for bonding with the pressure-sensitive adhesive.

17. A device according to claim 1, wherein the base substrate and the adhesive carrier substrate are each rectangular.

18. A method for performing a master processing operation on a selected substrate, the method comprising:
providing a device comprising:
(i) a base substrate,
(ii) an adhesive carrier substrate having an inner surface facing the base substrate,
(iii) a layer of pressure-sensitive adhesive provided on the inner surface of the adhesive carrier substrate, and
(iv) a release liner separating the base substrate from the adhesive carrier substrate, the release liner having a release surface engaging the layer of pressure-sensitive adhesive;
separating the base substrate from the release liner and the adhesive carrier substrate to enable the selected substrate to be positioned in a master processing position;
positioning the selected substrate in the master processing position; and
with the selected substrate in the master processing position, pulling the release liner in an activating direction generally parallel to the base substrate and the selected substrate so as to progressively remove the release liner from the adhesive carrier substrate and cause the pressure-sensitive adhesive to adhere to the selected substrate and any peripheral portions of the base substrate extending adjacent the periphery of the selected substrate.

19. A method according to claim 18, wherein:
the release liner is folded along a fold line extending in a transverse direction generally perpendicular to the activating direction to define two portions one of which is an activating portion,
the release liner has an outer surface facing the inner surface of the adhesive carrier substrate and an inner surface of the base substrate, the outer surface being the release surface, and
pulling the release liner in the activating direction is performed by pulling the activating portion of the release liner.

20. A method according to claim 19, wherein the base substrate includes a pressure-sensitive adhesive on the inner surface thereof and wherein positioning the selected substrate in the master processing position includes adhering the selected substrate to the pressure-sensitive adhesive on the inner surface of the base substrate.

21. A method according to claim 20, wherein the pressure-sensitive adhesive on the inner surface of the base substrate is a repositionable pressure-sensitive adhesive adapted for repositionably adhering the selected substrate in the laminating position during the master processing operation, and wherein adhering the selected substrate to the pressure-sensitive adhesive on the inner surface of the base substrate includes repositionably adhering the selected substrate to the repositionable pressure-sensitive adhesive.

22. A method according to claim 21, wherein the repositionable adhesive is provided as a strip extending transversely across the base substrate and wherein repositionably adhering the selected substrate to the repositionable pressure-sensitive adhesive includes engaging the selected substrate with the strip.

23. A method according to claim 19, wherein the activating portion includes a tab extending out from between the base substrate and the adhesive carrier substrate for facilitating manual grasping and pulling thereof;
wherein the method further comprises bringing the adhesive carrier substrate, the release liner, the selected substrate and the base substrate together into parallel relation with the selected substrate in the master processing position between the release liner and the base substrate prior to pulling the activating portion; and
wherein pulling the activating portion of the release liner in the activating direction includes manually grasping and pulling the tab.

24. A method according to claim 19, wherein the activating portion includes a string extending out from between the base substrate and the adhesive carrier substrate for facilitating manual grasping and pulling thereof;
wherein the method further comprises bringing the adhesive carrier substrate, the release liner, and the base substrate together into parallel relation with the selected substrate in the master processing position between the release liner and the base substrate prior to pulling the activating portion;
wherein pulling the activating portion of the release liner in the activating direction includes manually grasping and pulling the string.

25. A device according to claim 19 wherein separating the base substrate from the release liner and the adhesive carrier substrate includes folding the adhesive carrier substrate and the release liner apart from the base substrate so that each of the base and adhesive carrier substrates are laid on a planar surface, the release liner having a stiffness such that a portion thereof adjacent the fold line thereof will thereby delaminate from the adhesive carrier substrate and stand out;
wherein the positioning the selected substrate in the master processing position includes positioning the selected substrate on the folded apart base substrate; and
wherein the pulling the activating portion in the activating direction progressively removes the release liner from the adhesive carrier substrate and progressively pulls the adhesive carrier substrate over and into contact with the base substrate and the selected substrate.

26. A method according to claim 25, wherein the delamination and stand out of the portion of the release liner adjacent the fold line thereof exposes adhesive on the adhesive carrier substrate adjacent a nip defined where the adhesive carrier and base substrates are joined; and
wherein positioning the selected substrate on the folded apart base substrate includes engaging an edge of the selected substrate with the exposed adhesive.
